(19) United States
(12) Patent Application Publication
(10) Pub. No.: US 2014/0143646 A1
(43) Pub. Date: May 22, 2014

(54) SYSTEMS AND METHODS FOR DYNAMIC EXTERNAL DOCUMENT CONTENT

(71) Applicant: APPSENSE, INC., Warrington (GB)

(72) Inventors: Paul Keith BRANTON, Rochdale (GB); Richard James SOMERFIELD, Cheshire (GB)

(73) Assignee: APPSENSE, INC., Warrington (GB)

(21) Appl. No.: 13/678,869

(22) Filed: Nov. 16, 2012

(51) Int. Cl. G06F 17/24

(52) U.S. Cl. CPC G06F 17/24
USPC 715/234

(57) ABSTRACT

Systems and methods are provided for updating content of an electronic document. An electronic document is opened that includes a dynamic content portion configured to be updated with custom content each time the document is opened. A request for content is transmitted for the dynamic content portion to a remote server. The content for the dynamic content portion is received from the remote server. The electronic document is updated so that the dynamic content portion includes the received content. The electronic document is displayed with the received content.

### TECHNICAL FIELD

Embodiments of the invention generally relate to dynamic external document content.

### BACKGROUND

An electronic document (e.g., an email, a word processing document, etc.) can be created with a banner, logo, or other data that is incorporated into the electronic document. Such data is correct and current when the document is created. However, over the lifetime of the document, the data may become stale, incorrect, or out of date. For example, a document may contain a banner with the company logo and company contact information (e.g., contact details for the author of the document, for the main company office, and/or the like). After the electronic document is disseminated (e.g., stored on the creating computer, sent to other computers, etc.), the company logo, phone numbers, and/or address information may change. For example, if an email recipient of the document doesn't view it until two months after receipt, and the banner data changes during that two month period of time, the electronic document will have incorrect banner data when viewed.

Techniques exist to dynamically generate electronic documents (or portions thereof). For example, a mail merge application can automatically populate names and addresses of recipients for a letter from a database. However, after such electronic documents are dynamically generated, if the name and/or address of a recipient changes, the electronic document must often be manually updated (or recreated). Further, such documents can easily be duplicated (e.g., via email, copying, etc.). Updating the content of the duplicated electronic documents easily becomes an unmanageable, if not impossible, task. Additionally, it is difficult to compile statistics about disseminated documents (e.g., how often viewed, when viewed, viewed by whom, etc.), since it is difficult to track the documents.

### SUMMARY

In accordance with the disclosed subject matter, systems, methods, and non-transitory computer-readable media are provided for incorporating dynamic external content into electronic documents.

The disclosed subject matter includes a computerized method for updating content of an electronic document. A computing device opens an electronic document, wherein the electronic document comprises a dynamic content portion configured to be updated with custom content each time the document is opened. The computing device transmits a request for content for the dynamic content portion to a remote server. The computing device receives the content for the dynamic content portion from the remote server. The computing device updates the electronic document so that the dynamic content portion includes the received content. The computing device displays the electronic document with the received content.

The disclosed subject matter further includes a server for providing content for an electronic document. The server includes a database configured to store content for an electronic document. The server includes a processor in communication with the database, and configured to run a module stored in memory that is configured to cause the processor to receive a request for content for a dynamic content portion of an electronic document from a requesting computing device, wherein the dynamic content portion is configured to be updated with custom content each time the document is opened. The module stored in memory is further configured to cause the processor to locate, based on the request, the content in the database. The module stored in memory is further configured to cause the processor to transmit the content for the dynamic content portion to the requesting computing device so that the requesting computing device can modify the electronic document to include the content.

The disclosed subject matter further includes a non-transitory computer readable medium having executable instructions operable to cause an apparatus to store content for an electronic document. The instructions operable to cause an apparatus to receive a request for content for a dynamic content portion of an electronic document from a requesting computing device, wherein the dynamic content portion is configured to be updated with custom content each time the document is opened. The instructions operable to cause an apparatus to locate, based on the request, the content in the database. The instructions operable to cause an apparatus to transmit the content for the dynamic content portion to the requesting computing device so that the requesting computing device can modify the electronic document to include the content.

The techniques disclosed herein use a central repository to store dynamic document content, so that the dynamic content portions of all documents that use the dynamic content can be automatically updated by modifying data stored in a single, remote location. Further, the remote content location can compile statistics for the electronic documents, such as the number of times a document has been opened, the IP addresses of the computing device that opened the document, and/or other statistics. Such techniques can avoid the nearly impossible task of manually tracking down and replacing outdated content in individual documents (and copies thereof).

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary diagram of a system in accordance with some embodiments;

FIG. 2 is an exemplary diagram of an electronic document in accordance with some embodiments;

FIG. 3 is an exemplary diagram of a computerized method for adding dynamic remote content to an electronic document in accordance with some embodiments; and

FIG. 4 is an exemplary diagram of a computerized method for adding dynamic remote content to an electronic document that is customized for the requesting device, in accordance with some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

The disclosed techniques enable electronic documents to be created with one or more dynamic content portions that load data stored in a central repository at a remote server. Each time a computing device opens the electronic document, the computing device retrieves an up to date (and/or personalized) copy of the dynamic data from the remote computing device (e.g., from a web server). Therefore, regardless of how old the document is and/or how many times the electronic document was copied or disseminated to other electronic devices, the dynamic data is freshly loaded from the remote server. Therefore, if the dynamic data is updated on the remote computing device, the new data is transmitted and incorporated into the electronic document the next time the document is opened. Furthermore, data can be gleaned about the electronic document, and used to tailor the content added to the document. For example, the dynamic content can be tailored based on the location of the computing device opening the document. As another example, if an electronic document is viewed on a local company network, the dynamic data can be configured to display internal extension phone numbers in a document logo/banner, whereas if the same electronic document is viewed externally, the full phone numbers can be displayed instead of just the internal extensions.

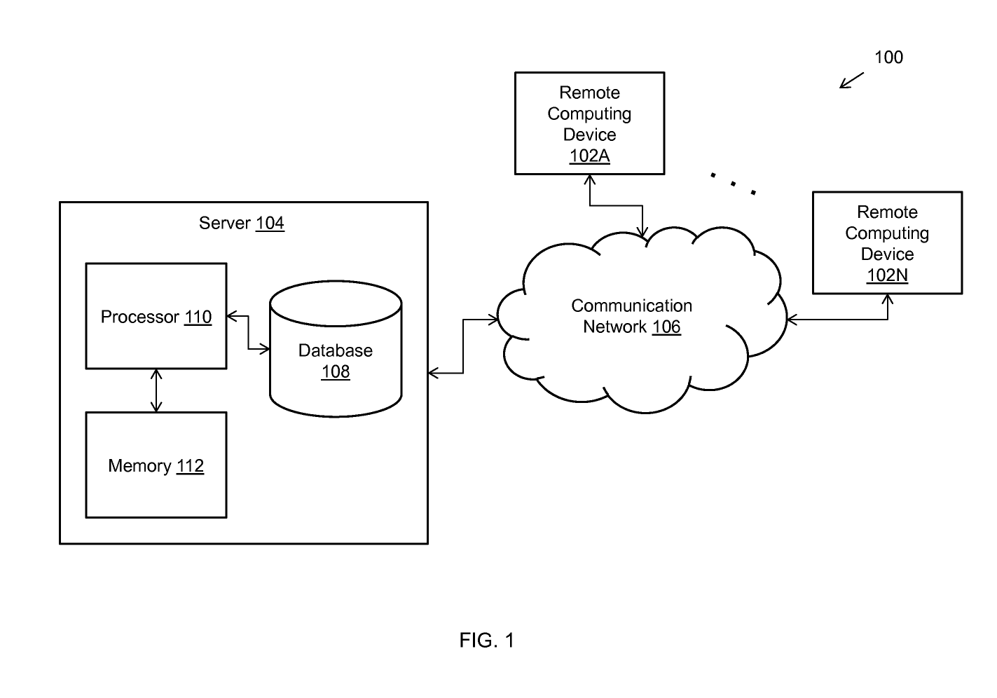

FIG. 1 is an exemplary diagram of a system 100 in accordance with some embodiments. The system 100 includes remote computing devices 102A through 102N (collectively, remote computing devices 102). Remote computing devices 102 are in communication with a server 104 through communication network 106. Server 104 provides content for electronic documents, and includes a database 108 configured to centrally store content for the electronic documents. Server 104 includes a processor 110 in communication with database 108 and memory 112. Processor 110 is configured to run modules stored in memory 112 (and/or database 108) that are configured to cause the processor to perform computerized functions, further described herein.

Referring to the remote computing devices 102, remote computing devices 102 can be, for example, cell phones, PDAs, smartphones, laptops, personal computers, and/or any other type of computing device. Remote computing devices 102 can store and access electronic documents with dynamic content portions. Remote computing devices 102A can update the dynamic content portions with remote content from server 104 each time remote computing devices 102 open the electronic document.

Referring to server 104, server 104 can store content for the dynamic content portions in database 108. The content can include, for example, data (e.g., phone numbers, addresses, hyperlinks, etc.), images (e.g., banners, logos, etc.), and/or other content that can be included in an electronic document. Server 104 transmits the custom content for a particular dynamic content portion to a requesting remote computing device 102. The custom content can be changed and/or updated (e.g., by an input device, not shown), such that the content for a dynamic content portion does not become stale or outdated. For example, a dynamic content portion can be for a company logo. If the company logo changes, the logo only needs to be updated in remote server 104. When remote computing device 102 requests content for the logo dynamic content portion, the new logo is automatically transmitted to the requesting remote computing device 102. Therefore, before the logo was updated, the document included the old logo (which was current at that time). However, once the logo is updated on server 104, the document will include the new logo each time the document is opened.

Communication network 106 can include a network or combination of networks that can accommodate private data communication. For example, communication network 106 can include a local area network (LAN), a private cellular network, a private telephone network, a private computer network, a private packet switching network, a private line switching network, a private wide area network (WAN), or any number of private networks that can be referred to as an Intranet. Such networks may be implemented with any number of hardware and software components, transmission media and network protocols. FIG. 1 shows network 106 as a single network; however, network 106 can include multiple interconnected networks listed above.

Processor 110 can be configured to implement the functionality described herein using computer executable instructions stored in a temporary and/or permanent non-transitory memory such as memory 112. Memory 112 can be flash memory, a magnetic disk drive, an optical drive, a programmable read-only memory (PROM), a read-only memory (ROM), or any other memory or combination of memories. Processor 110 can be a general purpose processor and/or can also be implemented using an application specific integrated circuit (ASIC), programmable logic array (PLA), field programmable gate array (FPGA), and/or any other integrated circuit. Similarly, database 108 may also be flash memory, a magnetic disk drive, an optical drive, a programmable read-only memory (PROM), a read-only memory (ROM), or any other memory or combination of memories. Computing device 104 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

The components of system 100 can include interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, for example optical, copper, and wireless, and in a number of different protocols some of which may be non-transient.

The software in server 104 can be divided into a series of tasks that perform specific functions. These tasks can communicate with each other as desired to share control and data information throughout server 104 (e.g., via defined APIs). A task can be a software process that performs a specific function related to system control or session processing. In some embodiments, three types of tasks can operate within server 104: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem can include critical tasks, controller tasks, and manager tasks. Some of the subsystems that run on server 104 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of server 104 by monitoring the various software and hardware components of server 104. Recovery control task subsystem can be responsible for executing a recovery action for failures that occur in server 104 and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide server 104 with an ability to set, retrieve, and receive notification of server configuration parameter changes and is responsible for storing configuration data for the applications running within server 104. A resource management subsystem can be responsible for assigning resources (e.g., processor and memory capabilities) to tasks and for monitoring the task's use of the resources.

In some embodiments, server 104 can reside in a data center and form a node in a cloud computing infrastructure. Server 104 can also provide services on demand such as Kerberos authentication, HTTP session establishment and other web services, and other services. A module hosting a client can be capable of migrating from one server to another server seamlessly, without causing program faults or system breakdown. A server 104 in the cloud can be managed using a management system.

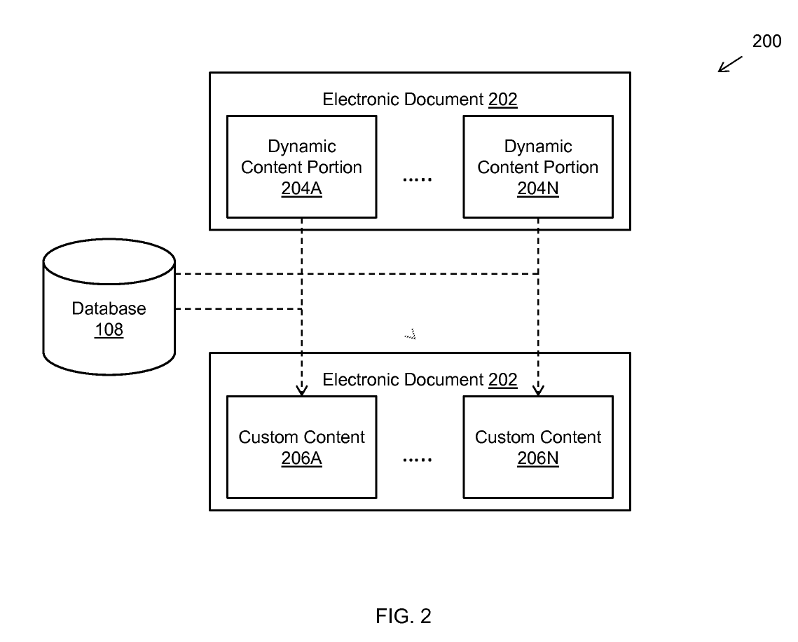

FIG. 2 is an exemplary diagram 200 of an electronic document 202 in accordance with some embodiments. The electronic document 202 includes dynamic content portion 204A through dynamic content portion 204N (collectively, dynamic content portions 204) configured to be updated with dynamic content each time the electronic document 202 is opened by a computing device. When opened, and as further described herein, the computing device retrieves content from database 108 and inserts the dynamic content into the dynamic content portions 204 to add custom content 206A through 206N (collectively referred to herein as custom content 206) to the electronic document 202. While FIG. 2 shows the electronic document 202 with a plurality of dynamic content portions 204, in some examples electronic document 202 only includes one dynamic content portion (e.g., just dynamic content portion 204A).

Dynamic content portions 204 can be, for example, a uniform resource locator (URL) linked to an active page on a website served by the remote server that provides the data for the dynamic content portions. When the computing device loads electronic document 202, the computing device requests the resource from the website at the associated URL. Dynamic content portions 204 can be created based on the particular type of electronic document being created (e.g., to ensure the dynamic content portion configuration is appropriate for the particular electronic document). For example, for Microsoft Office documents, the URL link can be added to the XML format of the document. The URL link can be added to the XML format by, for example, opening the docx format (which is a zip with XML and other formats) and editing the XML format to include the URL (e.g., via a software program configured to perform these tasks). The URL link can also be added to the XML format by saving a docx file as an XML format document, adding the link to the XML file, and resaving the XML file as a docx file. By adding the URL link this way, a Microsoft Office document can be opened without Microsoft Office displaying a warning that the electronic document includes external content (which is often displayed if the URL link is added to the document in other ways, requiring the user to click to proceed).

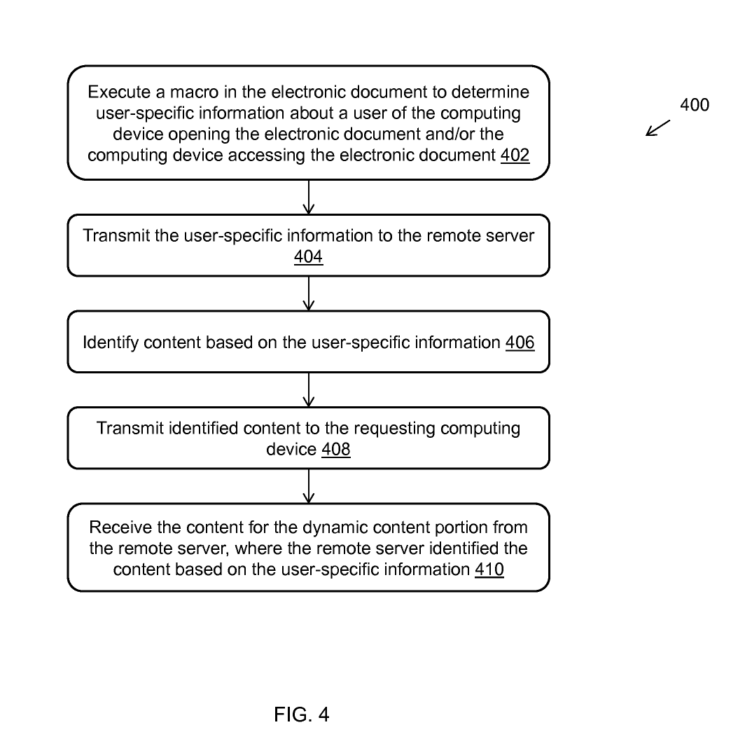

In some embodiments, electronic document 202 can include a macro (not shown). The macro can be a software program configured, for example, to determine user-specific information about a user of the computing device opening the electronic document, the computing device, and/or the like. For example, the macro can be configured to determine the user's name, the user's age, and/or other information about the user (e.g., which the remote server can use to tailor the dynamic content to the user, such as advertisements). As another example, the macro can be configured to determine the geographical location of the electronic device, the type of electronic device (e.g., smartphone, laptop, etc.), and/or the like. As is described with respect to FIG. 4, such information can be used to customize the dynamic content.

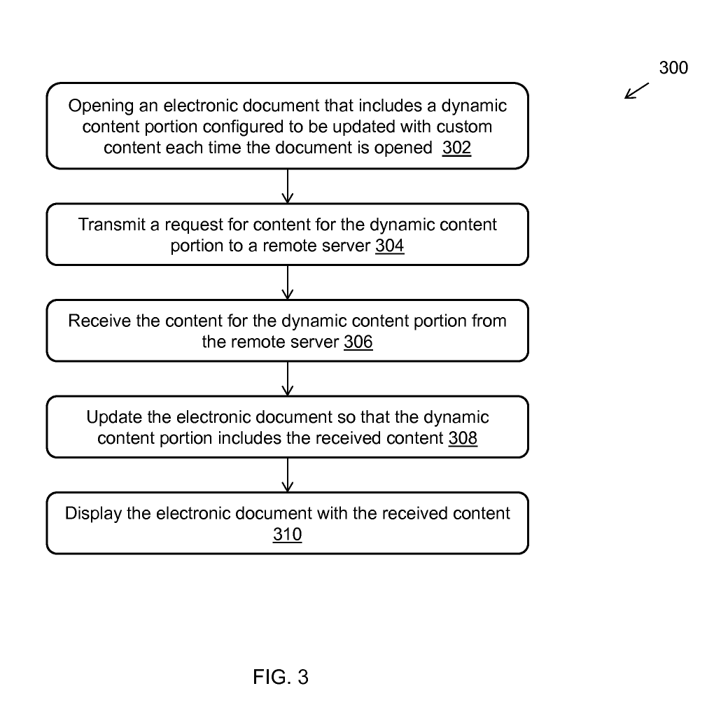

FIG. 3 is an exemplary diagram of a computerized method 300 for adding dynamic remote content to an electronic document in accordance with some embodiments. At step 302, a computing device (e.g., remote computing device 102A in FIG. 1) opens an electronic document (e.g., electronic document 202 in FIG. 2) that includes a dynamic content portion configured to be updated with custom content each time the document is opened. At step 304, the computing device transmits a request for content for the dynamic content portion to a remote server (e.g., to server 104, via communication network 106). At step 306, the computing device receives the content for the dynamic content portion from the remote server. At step 308, the computing device updates the electronic document so that the dynamic content portion includes the received content. The computing device displays the electronic document with the received content.

Referring to step 304, the computing device requests content for the dynamic content portion. For example, if the dynamic content portion includes a URL, the device can request the content from the remote server by accessing the URL. In other examples, the dynamic content portion can transmit a more traditional request to the remote server for the content.

The request can include data specific to the computing device. For example, the request for content can include an internet protocol (IP) address of the computing device (e.g., which may be automatically included in the request for content). The computing device also can transmit other data to the remote server, which the remote server can use to customize the content transmitted to the requesting device. FIG. 4 is an exemplary diagram of a computerized method 400 for adding dynamic remote content to an electronic document that is customized for the requesting device, in accordance with some embodiments. At step 402, the computing device executes a macro associated with the electronic document that determines user-specific information about a user of the computing device, the computing device, or any combination thereof. At step 404, the computing device transmits the user-specific information to the remote server. At step 406, the remote server identifies the content based on the user-specific information. At step 408, the remote server transmits the identified content to the requesting computing device. At step 410, the computing device receives the content for the dynamic content portion from the remote server.

Referring to step 402, the macro can be any type of software program configured to determine user-specific information. For example, the macro can be embedded in the electronic document. In some examples, the embedded macro is configured to determine the user-specific information. In some examples, the electronic document is configured to access a remote program (or data store) to identify the user-specific information.

Referring to step 404, the computing device can transmit the user-specific information separately from, or in conjunction with, the request for content. For example, the computing device may automatically transmit some information in the request, which the remote server can use to determine the user-specific information (e.g., the requesting device's IP address). In some embodiments, the information can be transmitted to the remote server in the URL. For example, the electronic document may include a URL hosted by the remote server to request the content. The requesting device can append data after the URL for each user-specific field (e.g., “?username=user1”).

Referring to step 406, the remote server can tailor the identified content to the user. In some examples, the remote server uses the IP address of the requesting device to determine user-specific information of the requesting device, and uses such information to customize the content for the requesting device. For example, the remote server can use the IP address to determine an approximate geographical location of the user. The remote server can use the geographical information to customize the requested content since the requesting device knows where the document will be opened by the requesting device. For example, if the device is in London, the remote device can select a banner with content tailored to London (or England, Europe, etc.). If the device is in the United States, the remote device can select a banner with content tailored to the United States (e.g., since contact numbers and/or addresses in the United States may be different than those in London).

Referring further to step 406, the remote device can use additional data determined by the macro to further customize the identified content (e.g., username, age, gender, company-specific information, type of requesting device, etc.). For example, the remote computing device can tailor an image to the person opening the document (e.g., to perform targeted advertising). In another example, the remote computing device can use company information to modify data to reflect the department or individual (e.g., extensions included in a banner, letter head for the document author, etc.). Referring to steps 408-410, the remote server transmits the content for the dynamic portion to the requesting device.

Referring to step 306 of FIG. 3, the computing device receives the content from the remote server. As described with reference to FIG. 4, the remote server can determine the content based on user-specific data, although the remote server need not do so. The remote server can also store data from the content requests, which can later be used to calculate statistics for the electronic documents. For example, the remote server can record the IP address of the requesting computing device (e.g., to count the number of times the content is requested, and the number of times it is requested for each IP address, etc.). In some examples, the remote server records the user-specific information, which can be used to compile more robust statistics. The remote server can also globally store how many times a document has been opened (e.g., using a counter).

In some embodiments, the remote server can add a uniquely identifiable marker to the content before transmitting the content to the requesting device. For example, the remote server can add a marker code to an image for a dynamic content portion. The marker code can be used, for example, to identify printed copies of the document. For example, the marker code can be indicative of the time and/or date that the computing device opened the electronic document. The remote server can customize the marker code so that it is indicative of when the remote server received the request for content. In some embodiments, the marker code is indicative of a particular version of content stored by the remote server. Such a marker code can be used to determine which version of the content the document includes.

The uniquely identifiable markings could be, for example, subtle modifications to the existing graphics (e.g., in the case of an image or banner), or additional markings (e.g., data characters, text, etc.). The remote server can use a predictable algorithm to calculate the markings In some embodiments, the algorithm can calculate the modifications based on user-specific data to customize the markings to a particular user (e.g., by using a username). For graphical modifications, the markings can be identified by subtracting the original (unmarked) images from the marked image. The differences between the two results in a signature that can identify the user who requested that image, the time the image was requested, and/or any other desired information.

The uniquely identifiable markings can be used when the document is converted to a different format that is no longer able to maintain the dynamic content. For example, a document may not be able to maintain the dynamic content if it is converted to a format that doesn't support dynamic images, or if printed to paper. Map makers and printer manufacturers, for example, use a “signature” approach to add identifiable data to the documents so that they can be traced back to the original source. Map makers, for example, often add minor ‘errors’ in the map, so that they know the error would only be reproduced if it is a direct copy. Printer manufacturers, for example, can add small yellow dots to printed copies that are very hard to see, but which uniquely identify the printer device.

Referring to step 308, the computing device updates the electronic document so that the dynamic content portion includes the received content. Thus the electronic document can be displayed to the user with the latest content information, ensuring that it includes the most up-to-date information available. The computing device can execute the process described in FIG. 3 transparently to the user, so the user is not aware that the contents of the document are being updated with new information. Further, if, for example, a user tries to open a document but cannot reach the remote server (e.g., the user does not have an internet connection), default content can be included in the electronic document (e.g., which informs the user that the content may be out of date since the computing device cannot request updated content).

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for updating content of an electronic document, the method comprising:
opening, by a computing device, an electronic document, wherein the electronic document comprises a dynamic content portion configured to be updated with custom content each time the document is opened;
transmitting, by the computing device, a request for content for the dynamic content portion to a remote server;
receiving, by the computing device, the content for the dynamic content portion from the remote server;
updating, by the computing device, the electronic document so that the dynamic content portion includes the received content; and
displaying, by the computing device, the electronic document with the received content.

2. The method of claim 1, wherein the request for content comprises an internet protocol (IP) address of the computing device, the method further comprising:
receiving the content, wherein the remote server identified the content based on the IP address.

3. The method of claim 1, wherein the electronic document comprises a uniform resource locator (URL) for a web page served by the remote server, and transmitting the request comprises requesting the content from the remote server by accessing the URL.

4. The method of claim 3, wherein the URL is contained in an XML format of the electronic document.

5. The method of claim 1, wherein the received content comprises a marker code that code allows identification of a printed copy of the electronic document.

6. The method of claim 1, wherein the electronic document comprises a macro configured to determine user-specific information about a user of the computing device, the computing device, or any combination thereof, the method further comprising:
executing the macro to determine the user-specific information; and
transmitting the user-specific information to the remote server.

7. The method of claim 6, further comprising receiving the content, wherein the remote server identified the content based on the user-specific information.

8. The method of claim 1, wherein the dynamic content portion comprises a banner, a logo, data, or any combination thereof

9. A server for providing content for an electronic document, the server comprising:
a database configured to store content for an electronic document; and
a processor in communication with the database, and configured to run a module stored in memory that is configured to cause the processor to:
receive a request for content for a dynamic content portion of an electronic document from a requesting computing device, wherein the dynamic content portion is configured to be updated with custom content each time the document is opened;
locate, based on the request, the content in the database; and
transmit the content for the dynamic content portion to the requesting computing device so that the requesting computing device can modify the electronic document to include the content.

10. The server of claim 9, wherein the module stored in memory is configured to cause the processor to record the internet protocol (IP) address of the requesting computing device.

11. The server of claim 10, wherein the module stored in memory is configured to cause the processor to locate the content in the database based on the IP address of the requesting device.

12. The server of claim 9, wherein the module stored in memory is configured to cause the processor to:
receive, from the requesting device, user-specific information about a user of the requesting device, the requesting device, or any combination thereof; and
record the user-specific information.

13. The server of claim 12, wherein the module stored in memory is configured to cause the processor to locate the content in the database based on the user-specific information.

14. A non-transitory computer readable medium having executable instructions operable to cause an apparatus to:
store content for an electronic document;
receive a request for content for a dynamic content portion of an electronic document from a requesting computing device, wherein the dynamic content portion is configured to be updated with custom content each time the document is opened;
locate, based on the request, the content in the database; and
transmit the content for the dynamic content portion to the requesting computing device so that the requesting computing device can modify the electronic document to include the content.

15. The computer readable medium of claim 14, having executable instructions operable to cause an apparatus to record the internet protocol (IP) address of the requesting computing device.

16. The computer readable medium of claim 15, having executable instructions operable to cause an apparatus to locate the content in the database based on the IP address of the requesting device.

17. The computer readable medium of claim 14, having executable instructions operable to cause an apparatus to:
receive, from the requesting device, user-specific information about a user of the requesting device, the requesting device, or any combination thereof; and
record the user-specific information.

18. The computer readable medium of claim 17, having executable instructions operable to cause an apparatus to locate the content in the database based on the user-specific information.
